(19) United States
(12) Patent Application Publication
(10) Pub. No.: US 2011/0299862 A1
(43) Pub. Date: Dec. 8, 2011

(54) PRINTING APPARATUS, METHOD FOR CONTROLLING THE SAME, AND STORAGE MEDIUM

(75) Inventor: Yasuhiro Kozuka, Tokyo (JP)

(73) Assignee: CANON KABUSHIKI KAISHA, Tokyo (JP)

(21) Appl. No.: 13/152,151

(22) Filed: Jun. 2, 2011

(30) Foreign Application Priority Data
Jun. 4, 2010 (JP) 2010-129213

(51) Int. Cl. G03G 15/00

(52) U.S. Cl. 399/19

(57) ABSTRACT

An image forming apparatus control unit interrupts print processing when it determines that a predetermined factor has occurred. When the print processing is restarted, the image forming apparatus control unit controls a printing unit to perform print processing on a specific number of sheets and then, after determining that a result of inspection for the specific number of sheets does not indicate a print failure, start print processing on sheets following the specific number of sheets.

### BACKGROUND OF THE INVENTION

1. Field of the Invention

The present invention relates to a printing apparatus, a method for controlling the printing apparatus, and a storage medium.

2. Description of the Related Art

In the print on demand (POD) industry, it is necessary to inspect the quality of a print output and, therefore, visual inspection has conventionally been performed by an operator. In recent years, an automatic inspection apparatus enabling automatic inspection has been developed.

In the event of paper jam, for example, since a fine piece of paper may remain in the printing apparatus, paper jam is more likely to occur again than is in a normal state. For this reason, when printing is restarted immediately after recovery from jam, a number of print sheets remaining in a conveyance path may have been wasted if a failure (NG) occurs again.

Japanese Patent Application Laid-Open No. 2002-287446 discusses a technique for preventing successive jam caused by a plurality of print sheets at the time of restart operation after recovery from jam.

Japanese Patent Application Laid-Open No. 2002-287446 discusses a printing apparatus that, at the time of restart operation after recovery from jam, checks paper discharge by using a sensor to detect completion of an image forming operation for the first sheet and, after that, starts an image forming operation for the second and subsequent sheets.

An ordinary printing apparatus is likely to cause smeared paper due to flying recording material such as toner or cause other image defects, in particular, immediately after recovery from jam.

However, the technique discussed in Japanese Patent Application Laid-Open No. 2002-287446 cannot avoid the occurrence of the above-mentioned smeared paper or other image defects after recovery from jam. After recovery, a large number of print sheets produced by an image forming operation on the second and subsequent sheets may be wasted since they are determined to be failed in inspection because of smeared paper or other image defects.

### SUMMARY OF THE INVENTION

The present invention is directed to a printing apparatus capable of efficiently producing a high-quality print output without wasting paper by preventing smeared paper and an image defect due to recording material as well as preventing paper and recording material from being wasted, even immediately after recovery processing which is relatively highly likely to cause a print failure.

According to an aspect of the present invention, a printing apparatus includes a printing unit configured to perform print processing on a sheet based on first image data, an acquisition unit configured to acquire a result of inspection for inspecting whether a print failure occurs in the print processing by comparing the first image data with second image data generated by reading the sheet on which the print processing has been performed, and a control unit configured to control, when print processing is interrupted and then restarted, the printing unit to perform print processing on a specific number of sheets and then, after determining that a result of inspection for the specific number of sheets does not indicate a print failure, start print processing on sheets following the specific number of sheets.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an exemplary configuration of a system including a printing apparatus according to an exemplary embodiment of the present invention.

FIG. 2 is a block diagram illustrating an exemplary control configuration of an image forming device unit.

FIG. 3 is a sectional view illustrating an internal configuration of the image forming device unit.

FIG. 4 is a sectional view illustrating a configuration of an inspection device unit.

FIG. 5 is a top view illustrating the inspection device unit and a conveyance belt.

FIG. 6 is a flow chart illustrating electrical processing by the inspection device unit.

FIGS. 7A and 7B illustrate a method for image comparison by an image comparison and determination unit.

FIG. 8 is a sectional view illustrating an exemplary configuration of a finisher unit.

FIG. 9 illustrates an exemplary configuration of a control system of the finisher unit.

FIG. 10 is a flow chart illustrating processing by an image forming device unit according to a first exemplary embodiment of the present invention.

FIG. 11 is a flow chart illustrating processing by an inspection device unit according to the first exemplary embodiment.

FIG. 12 illustrates exemplary portions where paper jam occurs.

FIG. 13 is a flow chart illustrating processing by an inspection device unit according to a second exemplary embodiment of the present invention.

FIGS. 14A and 14B illustrate an exemplary user interface (UI) processing screen according to the second exemplary embodiment.

FIG. 15 is a flow chart illustrating processing by an image forming device unit according to a third exemplary embodiment of the present invention.

### DESCRIPTION OF THE EMBODIMENTS

Various exemplary embodiments, features, and aspects of the invention will be described in detail below with reference to the drawings.

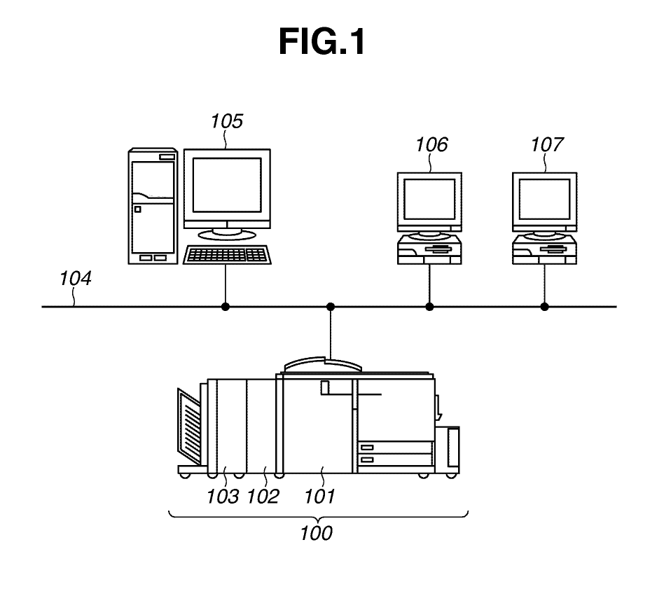

FIG. 1 illustrates an exemplary configuration of a system including a printing apparatus according to an exemplary embodiment of the present invention.

Referring to FIG. 1, the printing apparatus (image forming apparatus) 100 includes an image forming device unit 101, an inspection device unit 102, and a finisher unit 103.

The image forming device unit 101 processes various types of input data and prints data on a print medium such as printing paper. The inspection device unit 102 receives from the image forming device unit 101 a print medium on which the print processing has been performed, and inspects the state of the print medium. Specifically, the inspection device unit 102 checks the state of print processing on the print medium (inspects whether a print failure occurs in print processing). The finisher unit 103 performs post-print process (sorting, stapling, folding, etc.) according to a desired output form for the print medium inspected by the inspection device unit 102.

The image forming device unit 101 is communicably connected with an external print server 105 and client computers (client personal computers (PCs)) 106 and 107 via a network 104.

In the present exemplary embodiment, the printing apparatus 100 is an inline inspection apparatus which performs printing (image formation), image inspection, and finishing processes in a consistent way.

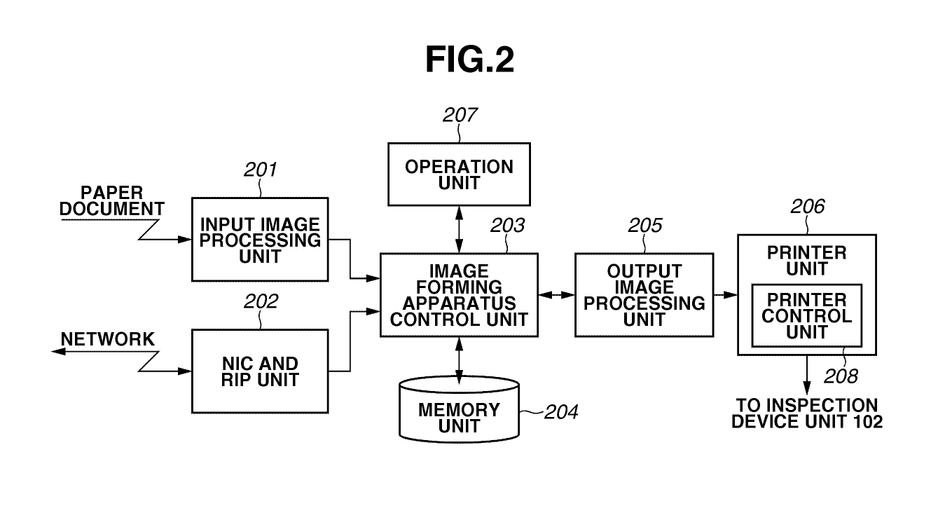

FIG. 2 is a block diagram illustrating an exemplary control configuration of the image forming device unit 101.

Referring to FIG. 2, an input image processing unit 201 scans a paper document via an image scanning apparatus (scanner unit 301) and applies image processing to relevant scan image data. The input image processing unit 201 outputs the processed image data to an image forming apparatus control unit 203.

A network interface control (NIC) unit of a NIP and raster image processor (RIP) unit 202 inputs image data (mainly PDL data) via the network 104 and outputs it to a RIP unit, and transmits image data and apparatus information in the image forming apparatus 100 to the outside via the network 104. A RIP unit of the NIC and RIP unit 202 decodes the input PDL data and performs RIP rasterization. The NIC and RIP unit 202 outputs the processed data to the image forming apparatus control unit 203.

The image forming apparatus control unit 203 has a function of controlling input and output data. The image forming apparatus control unit 203 inputs the image data and temporarily stores it in a storage unit 204. The image forming apparatus control unit 203 temporarily stores image data in the storage unit 204 and loads the image data from the storage unit 204 as required.

An output image processing unit 205 inputs image data from the image forming apparatus control unit 203, applies image processing necessary for printing to the image data, and outputs the processed image data to a printer unit 206. Under control of a printer control unit 208, the printer unit 206 feeds sheets one by one and prints on each sheet the image data generated by the output image processing unit 205. The printer unit 206 sends out the printed sheet to the inspection device unit 102.

An operation unit 207 is used to select any of various functions of the image forming device unit 101 and instruct it to perform an operation.

The image forming apparatus control unit 203 includes a central processing unit (CPU) and a read-only memory (ROM). Various functions can be achieved when the CPU loads a relevant computer-readable program from the ROM and then executes it.

Processing by each unit illustrated in FIG. 2 may be achieved either by hardware or software. When achieved by software, a CPU (not illustrated) in the image forming device unit 101 loads a relevant computer-readable program (software) from a ROM (not illustrated) therein and then executes it.

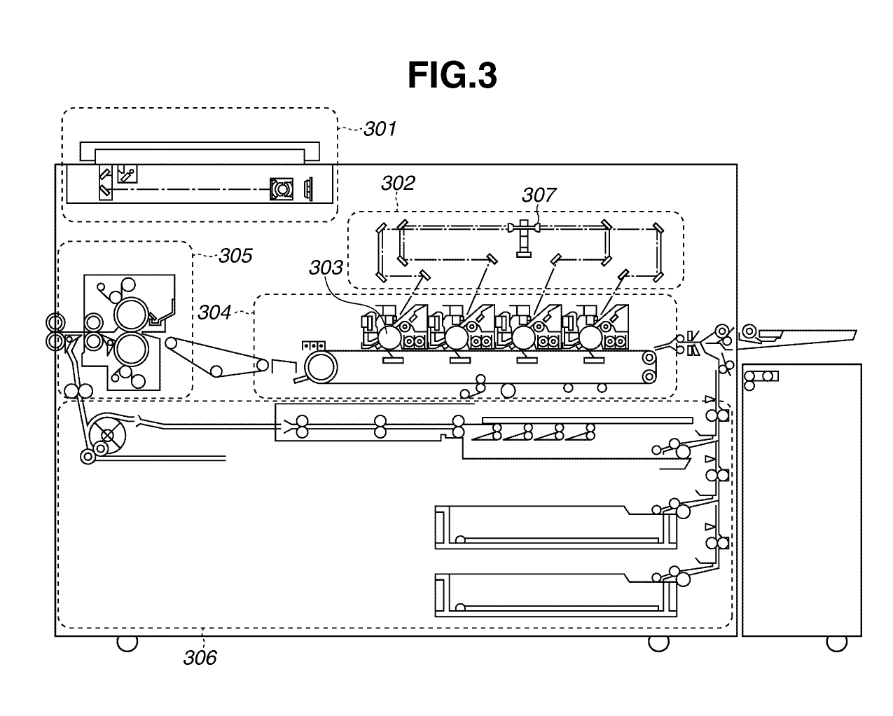

FIG. 3 is a sectional view illustrating an internal configuration of the image forming device unit 101.

The image forming device unit 101 includes the scanner unit 301, a laser exposure unit 302, a rotational polygon mirror 307, photosensitive drums 303, an image forming unit 304, a fixing unit 305, a feed and conveyance unit 306, and the printer control unit 208.

The scanner unit 301 illuminates a document placed on a document positioning plate, optically scans a document image, converts the image into an electrical signal to generate image data. An automatic document feeder (ADF) may be provided on the scanner unit 301 to feed sheets one by one from a stack of document sheets placed on the ADF, enabling a plurality of document sheets to be scanned in succession.

The laser exposure unit 302 emits laser light modulated according to the image data to the polygon mirror 307 rotating at a constant angular speed to irradiate the photosensitive drums 303 with reflected scanning light.

The image forming unit 304 includes a plurality of development units (development stations) for respective colors. In the present exemplary embodiment, the image forming unit 304 includes four development units for cyan (C), magenta (M), yellow (Y), and black (K). Each of the four development units performs a known electrophotographic process. The electrophotographic process includes rotatably driving the photosensitive drums 303, charging them with respective chargers, developing latent images (formed on the photosensitive drums 303 by the laser exposure unit 302) by using toner, transferring developed images onto a sheet, and collecting minute toner remaining on the photosensitive drums 303.

When a predetermined time has elapsed since the development station for cyan starts image forming operation, the four development units arranged in order of cyan (C), magenta (M), yellow (Y), and black (K) sequentially perform image forming operation for magenta, yellow, and black. This timing control enables transferring onto a sheet a full-color toner image without color misregistration. Although the present exemplary embodiment assumes a color printer, the printer is not limited thereto but may be a monochrome printer which mounts only a development unit for black.

The fixing unit 305 includes a combination of rollers and belts. The fixing unit 305 further includes a heat source such as a halogen heater to melt and fix with heat and pressure the toner image transferred onto the sheet by the image forming unit 304. Although the present exemplary embodiment indicates an image forming apparatus employing the electrophotographic process, the present invention is not limited thereto but may be based on an image forming apparatus employing other printing methods such as the inkjet method and sublimation method.

The feed and conveyance unit 306 includes at least one sheet storage unit such as a sheet cassette and a paper deck. The feed and conveyance unit 306 separates one sheet from a plurality of sheets stored in the sheet storage unit following an instruction of the image forming apparatus control unit 203, and conveys the sheet to the image forming unit 304 and the fixing unit 305. While the sheet is being conveyed, the four development stations transfer respective color toner images onto the sheet to form a full-color toner image thereon. When forming an image on both sides of a sheet, the feed and conveyance unit 306 controls sheet conveyance so that the sheet having passed the fixing unit 305 passes through again the conveyance path toward the image forming unit 304.

The printer control unit 208 controls the laser exposure unit 302, the polygon mirror 307, the photosensitive drums 303, the image forming unit 304, the fixing unit 305, and the feed and conveyance unit 306. The printer control unit 208 communicates with the image forming apparatus control unit 203, which totally controls the image forming device unit 101 to control the above-mentioned units according to an instruction of the image forming apparatus control unit 203. The printer control unit 208 instructs the image forming apparatus control unit 203 to manage the states of the scanner unit 301, the laser exposure unit 302, the polygon mirror 307, the photosensitive drums 303, the image forming unit 304, the fixing unit 305, and the feed and conveyance unit 306 to ensure their smooth operations in a totally harmonized way.

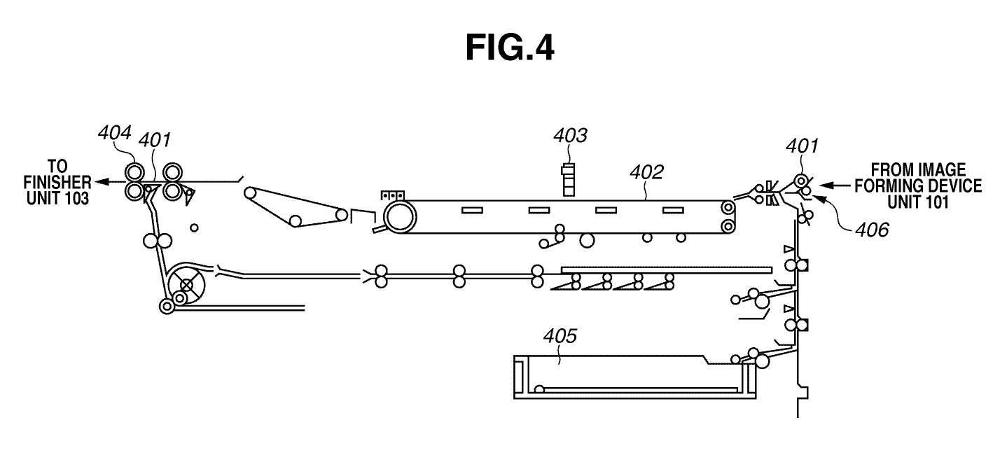

FIG. 4 is a sectional view illustrating a configuration of the inspection device unit 102.

As illustrated in FIG. 4, when a sensor 406 detects a sheet printed out by the image forming device unit 101 (a print medium on which the print processing has been performed by the image forming device unit 101), a feed roller pair 401 sends out the sheet to the inspection device unit 102. A conveyance belt 402 conveys the sheet fed by the feed roller pair 401. Then, an inspection sensor 403 disposed above the conveyance belt 402 scans the print image on the print side of the print sheet conveyed by the conveyance belt 402, and determines whether the state of printing on the sheet indicates a print failure. Specifically, the inspection device unit 102 determines whether a print failure has occurred in the print processing by the image forming device unit 101.

When a result of inspection is determined to be success (OK) (normal), a discharge roller pair 404 discharges the relevant print sheet. Otherwise, when a result of inspection is determined to be failure (when a result of inspection indicates a print failure), the feed and conveyance unit 306 temporarily evacuates the relevant print sheet in a stacker unit 405.

Although not illustrated, another inspection sensor may be disposed under the conveyance belt 402 to scan a two-sided print sheet. Although, in the present exemplary embodiment, failed print sheets (sheets having a print failure as a result of inspection) are temporarily stacked in the stacker unit 405, the configuration is not limited thereto.

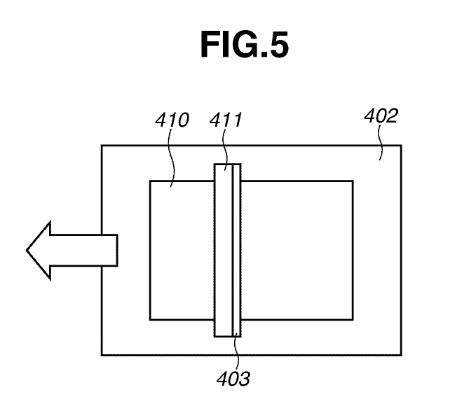

FIG. 5 is a top view illustrating the inspection device unit 102 and the conveyance belt 402.

As illustrated in FIG. 5, the inspection sensor 403 is a line sensor which scans an image on the entire surface of a sheet 410 conveyed by the conveyance belt 402. A sheet irradiation device 411 irradiates a sheet portion to be scanned by the inspection sensor 403.

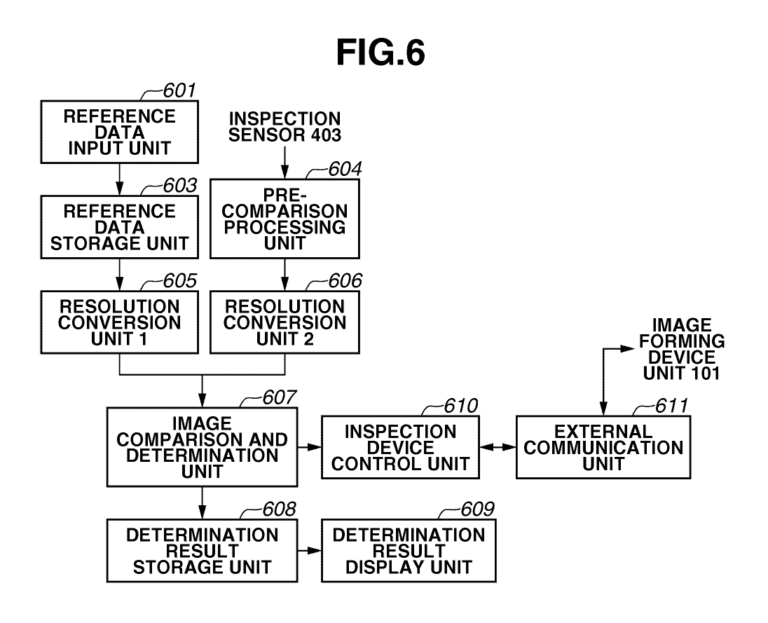

FIG. 6 is a flow chart illustrating electrical processing by the inspection device unit 102.

As illustrated in FIG. 6, the inspection sensor 403 scans a print output and converts scan image data of the print output into an electrical signal, and outputs the signal to a pre-comparison processing unit 604 as print output scan data. The pre-comparison processing unit 604 applies pre-comparison correction processing such as skew correction to the print output scan data, and outputs the scan data having undergone pre-comparison correction processing to a resolution conversion unit 2 (606).

A reference data input unit 601 inputs reference image data, i.e., original data to be compared with the print output scan data, and stores the reference image data in a reference data storage unit 603. The reference image data may be input from the image forming device unit 101, from a client PC, or via a certain capture interface directly mounted on the inspection device unit 102. The above-mentioned print output scan data corresponds to data generated by the inspection sensor 403 by scanning a print medium on which the print processing has been performed based on the above-mentioned reference image data.

To enable data comparison with an equal resolution, a resolution conversion unit 1 (605) converts the reference image data, stored in the reference data storage unit 603, into a certain resolution, and the resolution conversion unit 2 (606) converts the print output scan data, processed by the pre-comparison processing unit 604, into the same resolution. Then, the resolution conversion unit 1 (605) and the resolution conversion unit 2 (606) output respective data with a converted resolution to the image comparison and determination unit 607.

The image comparison and determination unit 607 compares the reference image data received from the resolution conversion unit 1 (605) with the print output scan data received from the resolution conversion unit 2 (606) to determine whether the sheet print state is normal (inspection). Specifically, the image comparison and determination unit 607 determines whether a print failure has occurred. A result of image comparison by the image comparison and determination unit 607 is stored in the determination result storage unit 608, and displayed by the determination result display unit 609 as required.

The inspection apparatus control unit 610 applies various types of control processing to the inspection device unit 102 and notifies the image forming apparatus control unit 203 in the image forming device unit 101 of the result of image comparison by the image comparison and determination unit 607 via an external communication unit 611. The image forming apparatus control unit 203 acquires the result of image comparison notified from the inspection apparatus control unit 610, and determines whether printing is to be continued or performs failure processing depending on the result of image comparison (success (OK)/failure (NG)).

Communication between the image forming device unit 101 and the inspection device unit 102 is achieved via a network, a general-purpose interface such as the universal serial bus (USB) interface, or a dedicated line.

Processing by each unit illustrated in FIG. 6 may be achieved either by hardware or software. When achieved by software, a CPU (not illustrated) in the inspection device unit 102 loads a relevant computer-readable program (software) from a ROM (not illustrated) therein and then executes it.

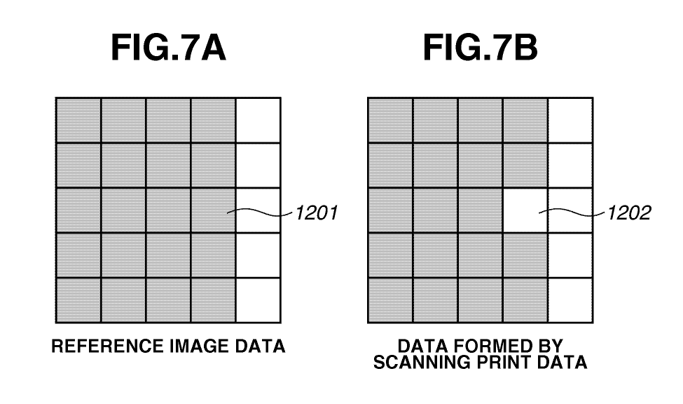

In the present exemplary embodiment, the resolution conversion units 1 (605) and 2 (606) convert the reference image data and the print output scan data (data formed by scanning print data), respectively, into a desired equal resolution to enable image data matching on a bit map basis. In the present exemplary embodiment, both types of image data are divided into a plurality of 5×5 blocks as illustrated in FIGS. 7A and 7B, and density comparison is performed in the RGB or CMYK color space on a pixel basis in each block. A setting for whether density comparison is performed in the RGB or CMYK color space can be changed depending on the image data. For example, density comparison is performed in the RGB color space for color image data, and density comparison is performed in the CMYK (only K) color space for monochrome image data. Image data comparison may be performed in a color space other than RGB and CMYK.

FIGS. 7A and 7B illustrate a method for image comparison by the image comparison and determination unit 607. FIGS. 7A and 7B illustrate exemplary image comparison on a 5×5 block basis.

FIG. 7A illustrates the reference image data (first image data), and FIG. 7B illustrates the print output scan data (second image data), each indicating a part of a monochrome image. Density data is multi-value data ranging from “0” to “255”.

The image comparison and determination unit 607 calculates a comparative value for each pixel by subtracting a reference image density data value from a scan data image density data value. Then, the image comparison and determination unit 607 compares the absolute value of the calculated comparative value with a permissible density difference (described below). When the absolute value of the comparative value is smaller than the permissible density difference (when the absolute value of the comparative value does not exceed the permissible density difference), the image comparison and determination unit 607 determines that a relevant pixel is successful (OK). Otherwise, it determines that the relevant pixel is failed (NG). The permissible density difference may be a value preset in a factory and stored in a flash ROM (not illustrated) or a value set by a user from the operation unit 207 of the image forming device unit 101 or from a display unit of the client PC, and then stored in the flash ROM.

Referring to FIGS. 7A and 7B, for example, when the density difference threshold value is set to “40”, the image density data value of a pixel 1201 is set to “255”, and the image density of a pixel 1202 is set to “0”, the absolute value of the comparative value becomes “0−255=255”. In this case, since the absolute value “255” of the comparative value is larger than the density difference threshold value “40”, the image comparison and determination unit 607 determines the relevant pixels as failed.

In this way, the image comparison and determination unit 607 applies similar determination processing to each pixel within the “5×5” block, and obtains a success (OK) determination rate on a block basis. Then, the image comparison and determination unit 607 compares the OK determination rate with an OK determination threshold value (described below) on a block basis. For example, a case where the OK determination threshold value is “80%” will be described below. When there is one failed pixel in the block, the OK determination rate is “96%.” In this case, since the OK determination rate (96%) is larger than the OK determination threshold value (80%), the result of inspection is determined to be success (OK) for the block. The inspection device unit 102 applies the above-mentioned inspection determination to the entire sheet surface. When the result of inspection is determined to be success (OK) for all blocks on the entire sheet surface, the result of inspection for the relevant sheet is determined to be success (OK). Otherwise, when the result of inspection is determined to be failure for at least one block, the result of inspection for the relevant sheet is determined to be failure.

The above-mentioned OK determination threshold value may be a value preset in a factory and stored in a flash ROM (not illustrated) or a value set by a user from the operation unit 207 of the image forming device unit 101 or from the display unit of the client PC and stored in the flash ROM.

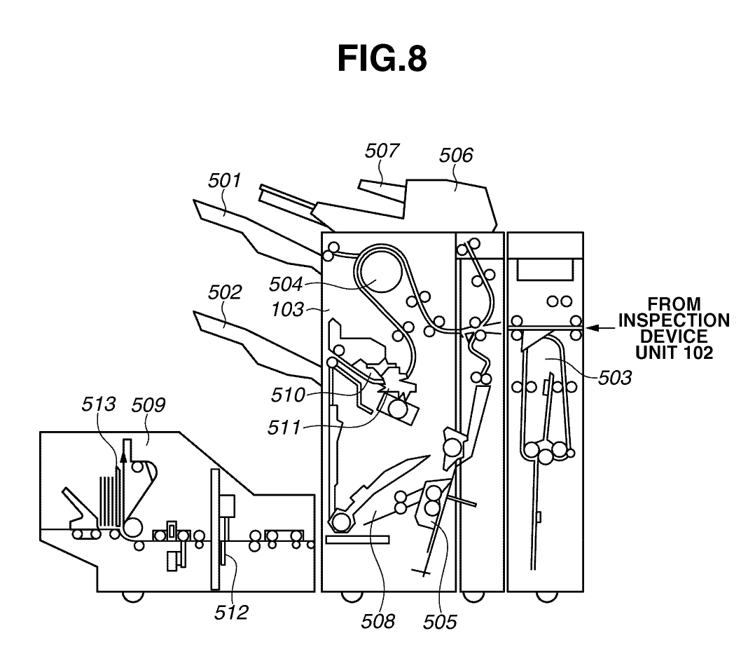

FIG. 8 is a sectional view illustrating an exemplary configuration of the finisher unit 103.

As illustrated in FIG. 8, a sheet discharged from the inspection device unit 102 is carried into the finisher unit 103. The finisher unit 103 is provided with a sample tray 501 and a stack tray 502, which are selected for sheet discharge according to the job type and the number of sheets to be discharged.

When the stapling mode is set for a job to be output (hereinafter referred to as target job), the finisher unit 103 discharges sheets onto the stack tray 502. In this case, before being discharged onto the stack tray 502, sheets are stacked on a processing tray 510 in the finisher unit 103 for each job. Then, a stapler 511 binds the sheets on the processing tray 510 and then the finisher unit 103 discharges a bundle of sheets onto the stack tray 502.

The finisher unit 103 includes the sample tray 501, the stack tray 502, a Z folding unit 503 for folding paper in Z character shape (Z folding processing), and a puncher 504 for perforating two (or three) holes for filing (punching). The finisher unit 103 can perform Z folding processing and punching by using the Z folding unit 503 and the puncher 504, respectively, according to the job type.

For example, when an operator applies Z folding processing setting via the operation unit 207 as a setting about sheet processing for the target job, the finisher unit 103 applies Z folding processing to sheets for the job by using the Z folding unit 503. Then, the finisher unit 103 lets a sheet having undergone Z folding processing pass through its internal path and then discharges it onto the stack tray 502 or the sample tray 501.

For example, when the operator applies punching setting via the operation unit 207 as a setting about sheet processing for the target job, the finisher unit 103 performs punching on sheets for the job by using the puncher 504. Further, the finisher unit 103 lets a sheet having undergone punching pass through its internal path and then discharges it onto the stack tray 502 or the sample tray 501.

The finisher unit 103 is provided with a saddle stitcher 505. The saddle stitcher 505 binds two central portions of a sheet, center-folds the sheet by using a roller pair for catching its central portion, and applies processing for creating a pamphlet-like booklet (bookbinding processing) to the sheet. A bundle of sheets bound by the saddle stitcher 505 is discharged onto the booklet tray 508. As mentioned above, the finisher unit 103 determines whether sheet processing such as bookbinding processing by the saddle stitcher 505 based on the sheet processing setting applied by the operator for the target job.

The finisher unit 103 is also provided with an inserter 506. The inserter 506 is used to send a sheet set in an insertion tray 507 to anyone of discharge trays such as the stack tray 502 and the sample tray 501 without letting it pass in a printer. Thus, a sheet set in the inserter 506 can be inserted between sheets (sheets printed by the printer unit 206) sent into the finisher unit 103.

Sheets are set in the insertion tray 507 of the inserter 506 by the operator in a face-up state, and sequentially fed from the uppermost sheet by a pickup roller.

Therefore, a sheet fed from the inserter 506 is conveyed to the stack tray 502 or the sample tray 501 and then discharged thereto in a face-down state. When sending out a sheet to the saddle stitcher 505, the sheet is once fed to the side of the puncher 504 and then returned on a switchback basis to feed it to the saddle stitcher 505, thus unifying the orientation of the sheet face. As mentioned above, the finisher unit 103 determines whether to perform sheet processing such as sheet insertion processing by the inserter 506 based on the sheet processing setting applied by the operator for the target job.

The finisher unit 103 is also provided with a trimmer (cutter) 509. A booklet (with saddle stitching) created by the saddle stitcher 505 is carried into the trimmer 509. In this case, after the booklet is fed by a predetermined length by a roller, and a cutter unit 512 cuts the booklet by a predetermined length. Thus, edges of a plurality of pages in the booklet are neatly aligned. Then, the booklet is stored in the booklet hold unit 513. As mentioned above, the finisher unit 103 determines whether to perform sheet processing such as cutting processing by the trimmer 509 based on the sheet processing setting applied by the operator for the target job.

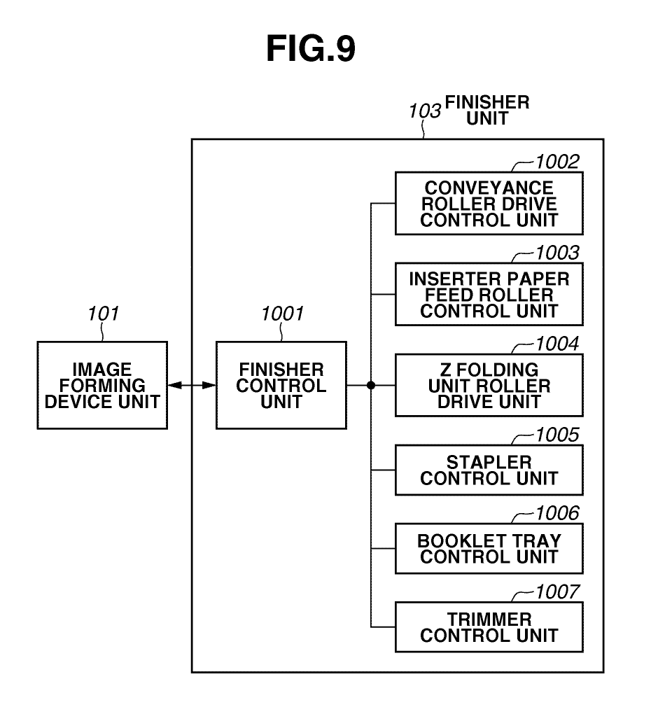

FIG. 9 illustrates an exemplary configuration of a control system of the finisher unit 103.

As illustrated in FIG. 9, the image forming apparatus control unit 203 in the image forming device unit 101 and the finisher control unit 1001 in the finisher unit 103 are connected via a dedicated communication line. The finisher control unit 1001 receives finisher setting information according to the job from the image forming device unit 101 to enable communication between control units 1002 to 1007 for controlling each function in the finisher unit 103 based on the received setting information.

The conveyance roller drive control unit 1002 guides a sheet to various finishing units based on job control information received from the finisher control unit 1001. When applying stapling processing, the finisher control unit 1001 communicates with a stapler control unit 1005 to receive status information of the stapler control unit 1005 and transmit the job control information to the stapler control unit 1005. The stapler control unit 1005 applies stapling processing according to the job control information to sheets and then discharges them.

The inserter feed roller control unit 1003, the Z folding unit roller drive unit 1004, the booklet tray control unit 1006, and a trimmer control unit 1007 are controlled according to the job control information received from the finisher control unit 1001 to produce a desired print output.

Processing by each unit illustrated in FIG. 9 may be achieved either by hardware or software. When achieved by software, a CPU (not illustrated) in the finisher unit 103 loads a relevant computer-readable program (software) from a ROM (not illustrated) therein and then executes it.

Processing to be performed when a situation requiring recovery processing arises in the printing apparatus 100 will be described below.

Processing by the image forming device unit 101 will be described below.

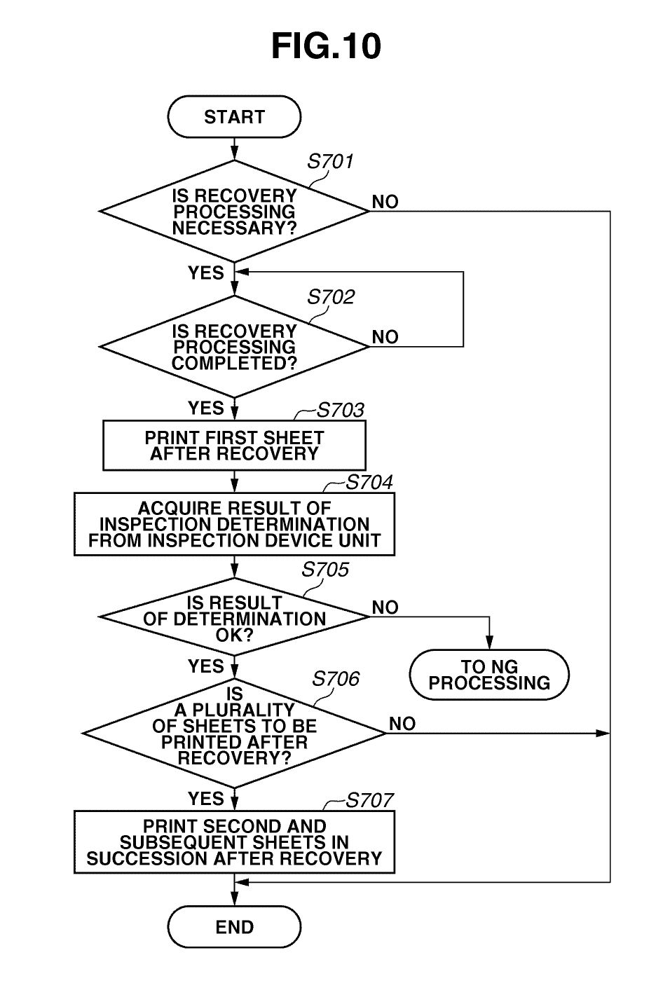

FIG. 10 is a flow chart illustrating processing by the image forming device unit 101 when a situation requiring recovery processing arises in the printing apparatus 100 according to a first exemplary embodiment of the present invention. Processing of this flow chart is performed by the image forming apparatus control unit 203.

During execution of continuous jobs, in step S701, the image forming apparatus control unit 203 determines whether any one unit in the printing apparatus 100 requires recovery processing, i.e., whether a factor requiring recovery processing has occurred. Factors requiring recovery processing will be described below. When the image forming apparatus control unit 203 determines that recovery processing is required (YES in step S701), it interrupts print processing and the processing proceeds to step S702. Otherwise (NO in step S701), the processing ends this flow chart to continue regular processing.

In step S702, the image forming apparatus control unit 203 waits for completion of recovery processing. When the image forming apparatus control unit 203 determines that recovery processing is completed (YES in step S702), the processing proceeds to step S703.

In step S703, the image forming apparatus control unit 203 controls the printing apparatus 100 to restart after-recovery job processing and then perform after-recovery print processing on the first sheet through intermittent print and inspection processing in which a result of inspection for print processing on one sheet is determined before starting print processing on a next sheet. Specifically, when print processing is interrupted for recovery processing and then restarted, the image forming apparatus control unit 203 performs after-recovery print processing on the first sheet, sends out the sheet to the inspection device unit 102, and waits for a response about a result of inspection from the inspection device unit 102. The inspection device unit 102 applies inspection determination to the first sheet after recovery processing output from the image forming device unit 101, and notifies the image forming apparatus control unit 203 of a result (state) of print processing thereon.

The first sheet printed in step S703 may be printed from a middle point of the job interrupted until recovery processing is performed, or may be reprinted from the beginning. Specifically, for example, suppose that paper jam occurs during printing of a fifth sheet for a job for printing 10 sheets and then recovery processing is performed. In this case, in step S703, the fifth sheet may be printed as after-recovery print processing, or the first sheet is reprinted as after-recovery print processing.

In step S704, the image forming apparatus control unit 203 receives (acquires) a result of inspection from the inspection device unit 102. In step S705, the image forming apparatus control unit 203 determines the received result of inspection.

When the image forming apparatus control unit 203 determines that the result of inspection is failure (NG) (a print failure: NO in step S705), the processing proceeds to failure processing. Although the failure processing by the image forming device unit 101 will not be described in detail, for example, the failure processing performs reprint processing on a sheet determined to be failed (NG) (a print failure) as a result of inspection.

Otherwise, when the image forming apparatus control unit 203 determines that the result of inspection is success (OK) (not a print failure: YES in step S705), the processing proceeds to step S706.

In step S706, the image forming apparatus control unit 203 determines whether a plurality of sheets is to be printed after recovery processing. When the image forming apparatus control unit 203 determines that a plurality of sheets is to be printed (YES in step S706), the processing proceeds to step S707. In step S707, the image forming apparatus control unit 203 controls the printing apparatus 100 to perform after-recovery print processing on the second and subsequent sheets, and the processing ends this flow chart. Specifically, when the image forming apparatus control unit 203 controls the printing apparatus 100 to perform after-recovery print processing on the first sheet through intermittent print and inspection processing and then, after determining that a result of inspection for the first sheet does not indicate a print failure, perform after-recovery print processing on the second and subsequent sheets through continuous print processing.

Otherwise, when the image forming apparatus control unit 203 determines that a plurality of sheets is not to be printed (NO in step S707), the processing ends this flow chart.

Processing by the inspection device unit 102 will be described below.

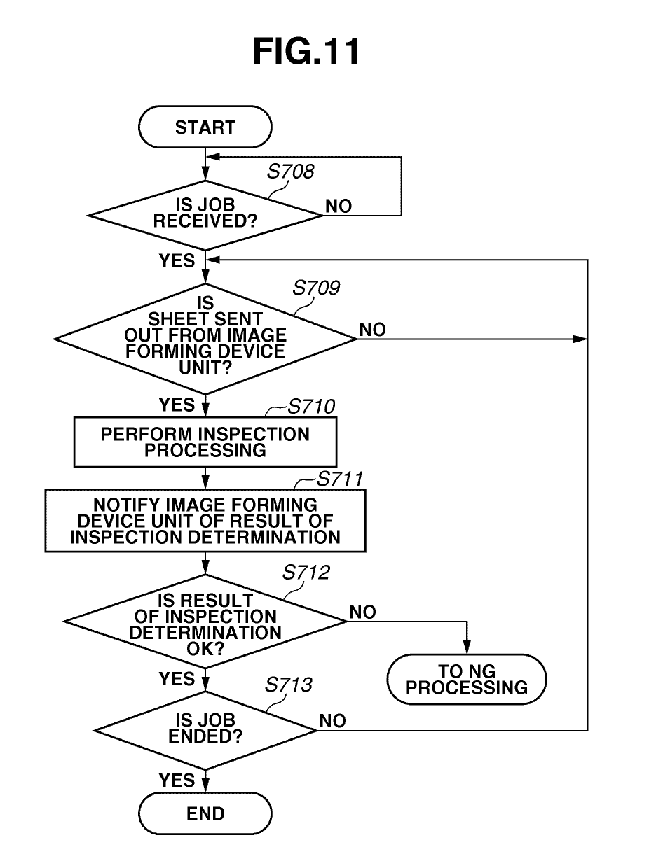

FIG. 11 is a flow chart illustrating processing by the inspection device unit 102 according to the first exemplary embodiment. Processing of this flow chart is performed by the inspection apparatus control unit 610.

In step S708, the inspection apparatus control unit 610 waits until the reference data input unit 601 receives a job (including the reference image data). When the inspection apparatus control unit 610 determines that a job is received (YES in step S708), the processing proceeds to step S709. The inspection apparatus control unit 610 may receive a job from the image forming device unit 101 via a network, from a client PC, or via a certain capture interface directly mounted on the inspection device unit 102.

In step S709, the inspection apparatus control unit 610 waits until a sheet is sent out from the image forming device unit 101 (until a sheet is detected by the sensor 406). When the inspection apparatus control unit 610 determines that a sheet is sent out from the image forming device unit 101 (YES in step S709), the processing proceeds to step S710. In step S710, the inspection apparatus control unit 610 applies inspection to the image on the sheet sent out from the image forming device unit 101. In inspection, the inspection sensor 403 scans the sheet to generate print output scan data. Then, the pre-comparison processing unit 604 processes the print output scan data. The resolution conversion unit 2 (606) converts the resolution of the print output scan data, and the resolution conversion unit 1 (605) converts the resolution of the reference image data. Then, the image comparison and determination unit 607 compares the reference image data with the print output scan data, each having an equal converted resolution, to determine a result of inspection.

In step S711, the inspection apparatus control unit 610 notifies the image forming device unit 101 of the result of inspection obtained in step S710, and the processing proceeds to step S712.

In step S712, the inspection apparatus control unit 610 determines whether the result of inspection obtained in step S710 is success (OK). When the inspection apparatus control unit 610 determines that the result of inspection is failure (NG) (NO in step S712), the processing proceeds to failure processing. Although the failure processing by the inspection device unit 102 will not be described in detail, even during processing of a received job for example, the inspection apparatus control unit 610 controls the inspection device unit 102 not to apply inspection to the remaining sheets.

Otherwise, when the inspection apparatus control unit 610 determines that the result of inspection is success (OK) (YES in step S712), the processing proceeds to step S713.

In step S713, the inspection apparatus control unit 610 determines whether the job is completed. When the inspection apparatus control unit 610 determines that the job is not completed (NO in step S713), the processing returns to step S709. The inspection apparatus control unit 610 controls the inspection device unit 102 to receive the next sheet sent out from the image forming device unit 101 and repeats processing in steps S709 to S713 until the job is completed.

Otherwise, when the inspection apparatus control unit 610 determines that the job is completed (YES in step S713), the processing ends this flow chart.

Recovery processing may be required by various factors such as paper out, paper jam (conveyance failure), toner replacement (recording material replacement), etc. The intermittent print and inspection processing (steps S703 to S705 in FIG. 10) is needed to be performed not for all factors requiring recovery processing (also referred to as recovery factors). Which recovery factor the intermittent print and inspection processing is to be triggered by may be determined by a user setting (factor setting). Alternatively, the image forming apparatus control unit 203 may determine whether the intermittent print and inspection processing is to be performed for each recovery factor.

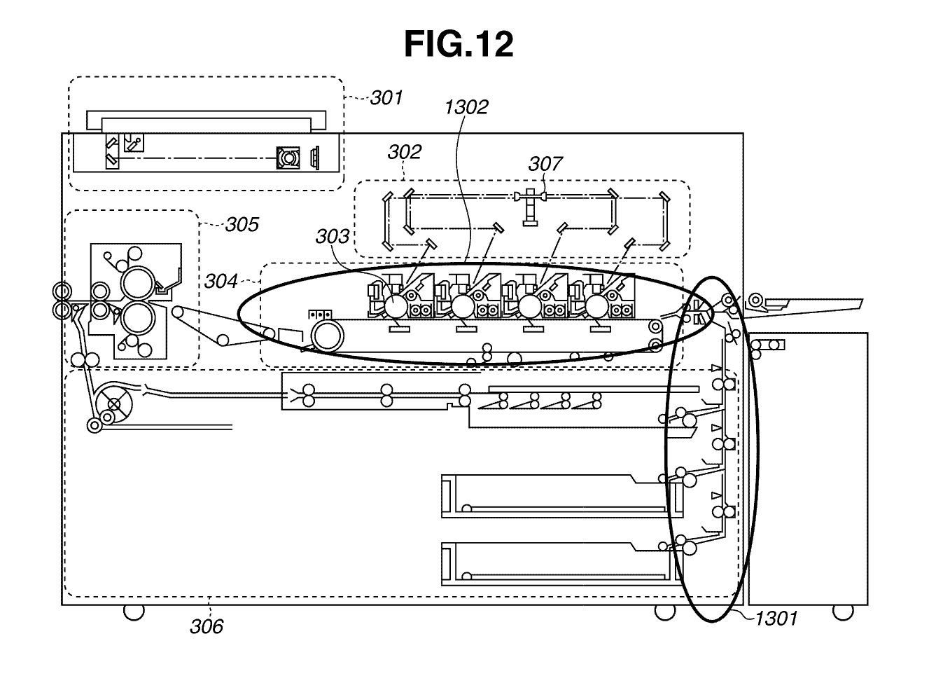

For example, recovery factors include jam in the image forming device unit 101, jam in the inspection device unit 102, jam in the finisher unit 103, and jam in other units. Jam is caused by a recovery factor occurring at different portions. Depending on a portion at which a recovery factor occurs, the image forming apparatus control unit 203 may determine whether after-recovery print processing for a specific number of sheets (one sheet in the present exemplary embodiment) is to be performed through intermittent print and inspection processing as is the case with the present exemplary embodiment. Paper jam will be described below with reference to FIG. 12.

FIG. 12 illustrates exemplary portions where paper jam occurs.

Referring to FIG. 12, a portion 1301 indicates the conveyance unit. For example, if a sheet exists only at this portion, scattering of toner is not relatively highly likely to occur in the development unit. Therefore, setting the after-recovery intermittent print and inspection processing is not so necessary.

A portion 1302 indicates the conveyance unit of the development system (the image forming unit 304). When a sheet exists at the portion 1302 and in the conveyance path thereafter, scattering of recording material such as toner may have occurred and, therefore, intermittent printing is effective.

In the case of paper out, since the result of inspection for an output image is not relatively highly likely to be failure, setting the intermittent print and inspection processing is not so necessary. In the case of toner out, the density of the first sheet after toner replenishment (after recording material replacement) is more likely to become unstable, the intermittent print and inspection processing is effective. Therefore, for example, at least one of a case where a sheet exists in the image forming unit 304, i.e., in the printing apparatus 100 and a case of toner out (a state where no toner remains) is recognized as a specific factor requiring recovery processing. Then, after recovery processing due to these specific factors, the image forming apparatus control unit 203 controls the printing apparatus 100 to print out one sheet, wait for a result of inspection by the inspection device unit 102 (perform intermittent print and inspection processing) and then, after determining that the result of inspection is success (OK), start continuous print processing for jobs for the second and subsequent sheets. After recovery processing due to a factor other than the above-mentioned specific factors, the image forming apparatus control unit 203 may control the printing apparatus 100 to simply start continuous print processing.

For example, when a user-specified factor occurs and the image forming apparatus control unit 203 interrupts print processing and detects that the interrupted print processing has been restarted, it may control the printing apparatus 100 to perform the processing in steps S703 to S707 in FIG. 10.

The present exemplary embodiment has specifically been described based on a case where the image forming apparatus control unit 203 performs after-recovery print processing on the first sheet through intermittent print and inspection processing and then, after determining that the result of inspection for the first sheet does not indicate a print failure, performs after-recovery print processing on the second and subsequent sheets through continuous print processing. However, when the image forming apparatus control unit 203 performs after-recovery print processing on a specific number of sheets (at least two sheets) through intermittent print and inspection processing, and determines that the result of inspection for the specific number of sheets does not indicate a print failure, the image forming apparatus control unit 203 may perform after-recovery print processing on sheets following the specific number of sheets through continuous print processing. In the intermittent print and inspection processing, the image forming apparatus control unit 203 determines a result of inspection for one sheet before starting print processing on the next sheet. In the continuous print processing, the image forming apparatus control unit 203 starts print processing without determining a result of inspection for each sheet.

Specifically, when a recovery factor occurs, the image forming apparatus control unit 203 interrupts print processing and then performs recovery processing. When the image forming apparatus control unit 203 detects that the print processing is interrupted and then restarted, it performs print processing on a specific number of sheets and then acquires a result of inspection for a specific number of sheets from the inspection device unit 102. Then, the image forming apparatus control unit 203 may control the printing apparatus 100 to start print processing on sheets following the specific number of sheets after determining that the result of print processing on the specific number of sheets does not indicate a print failure.

As mentioned above, at the time of recovery processing (due to a specific factor) for continuous jobs, the image forming apparatus according to the present exemplary embodiment performs print processing on one sheet (a specific number of sheets), waits for a result of inspection by the inspection device unit 102 and then, after determining that the result of inspection is success (OK), starts jobs for the second and subsequent sheets (sheets following the specific number of sheets). Thus, the present exemplary embodiment provides a printing apparatus capable of efficiently producing a high-quality print output without wasting paper by preventing smeared paper and an image defect due to recording material as well as preventing paper and recording material from being wasted, even immediately after recovery processing which is relatively highly likely to cause failure (a print failure) as a result of inspection.

In a second exemplary embodiment of the present invention, to further check a print output immediately after recovery processing, the inspection device unit 102 uses an inspection determination rate severer than a regular inspection determination rate in inspecting print processing on a specific number of sheets (one sheet for example) after recovery processing (due to a specific factor).

In the second exemplary embodiment, processing performed by the image forming device unit 101 when recovery processing arises is similar to the processing illustrated in FIG. 10.

Processing by the inspection device unit 102 according to the second exemplary embodiment will be described below.

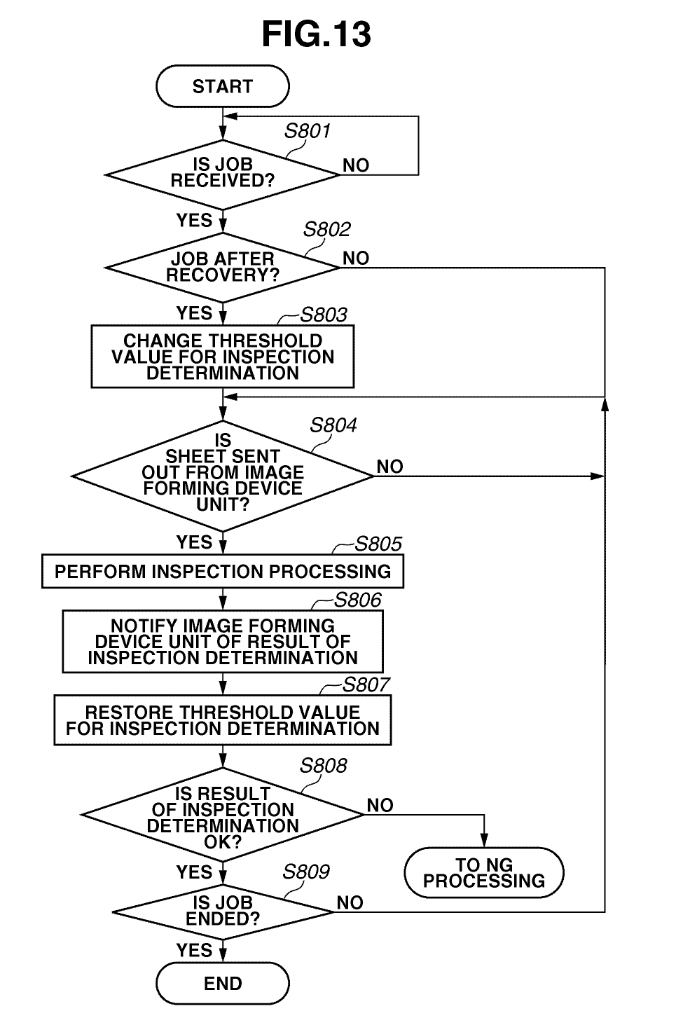

FIG. 13 is a flow chart illustrating processing by the inspection device unit 102 according to the second exemplary embodiment. Processing of this flow chart is performed by the inspection apparatus control unit 610.

In step S801, the inspection apparatus control unit 610 waits until the reference data input unit 601 receives a job (including reference image data). When the inspection apparatus control unit 610 determines that a job is received (YES in step S801), the processing proceeds to step S802.

In step S802, the inspection apparatus control unit 610 determines whether the job received in step S801 is a job after recovery processing. When the inspection apparatus control unit 610 determines that the received job is a job after recovery processing (YES in step S802), the processing proceeds to step S803.

In step S803, the inspection apparatus control unit 610 changes the threshold values (at least one of the density difference threshold value and the OK determination threshold value) to make the inspection determination rate severer. For example, the inspection apparatus control unit 610 changes the threshold values from the regular threshold values (a first density difference threshold value and a first OK determination threshold value) to the threshold values for after-recovery inspection (a second density difference threshold value and a second OK determination threshold value), and the processing proceeds to step S804. The regular threshold values (the first density difference threshold value and the first OK determination threshold value) and the threshold values for after-recovery inspection (the second density difference threshold value and the second OK determination threshold value) are stored, for example, in the flash ROM in the inspection device unit 102. Further, the regular threshold values (the first density difference threshold value and the first OK determination threshold value) and the threshold values for after-recovery inspection (the second density difference threshold value and the second OK determination threshold value) may be preset at a factory or set by the user from the operation unit 207 of the image forming device unit 101 or from the display unit of the client PC.

Otherwise, when the inspection apparatus control unit 610 determines that the received job is not a job after recovery processing (NO in step S802), the processing proceeds to step S804. Only when the inspection apparatus control unit 610 determines that the received job is a job after recovery processing due to the above-mentioned specific factors, the processing proceeds to step S803. When the inspection apparatus control unit 610 determines that the received job is a job after recovery processing due to a factor other than the specific factors, the processing may proceeds to step S804.

In step S804, the inspection apparatus control unit 610 waits until a sheet is sent out from the image forming device unit 101 (until a sheet is detected by the sensor 406). When the inspection apparatus control unit 610 determines that a sheet is sent out (YES in step S804), the processing proceeds to step S805. In step S805, the inspection apparatus control unit 610 applies inspection to the image on the sheet sent out from the image forming device unit 101. In inspection, the inspection sensor 403 scans the sheet to generate print output scan data. Then, the pre-comparison processing unit 604 processes the print output scan data. The resolution conversion unit 2 (606) converts the resolution of the print output scan data, and the resolution conversion unit 1 (605) converts the resolution of the reference image data. Then, the image comparison and determination unit 607 compares the reference image data with the print output scan data, each having an equal converted resolution, to determine a result of inspection. Specifically, the inspection apparatus control unit 610 according to the present exemplary embodiment controls the inspection device unit 102 to apply inspection to a specific number of sheets (one sheet in the present exemplary embodiment) after recovery processing (due to a specific factor) based on a second level higher than a first level (an inspection level before recovery processing). Specifically, the inspection apparatus control unit 610 differentiates a reference value for determining the state of print processing on a specific number of sheets after restarting the after-recovery print processing from a reference value for determining the state of print processing before interrupting (before restarting) print processing.

In the present exemplary embodiment, the inspection apparatus control unit 610 determines a result of inspection for the first sheet after recovery processing (due to a specific factor) based on threshold values severer than ones for regular inspection determination. Therefore, as processing to be performed when a result of inspection is determined to be failure, the inspection apparatus control unit 610 prompts the operator to determine whether the result of inspection falls within a tolerance. The following describes processing to be performed when a result of inspection for the first sheet after recovery processing is determined to be failure.

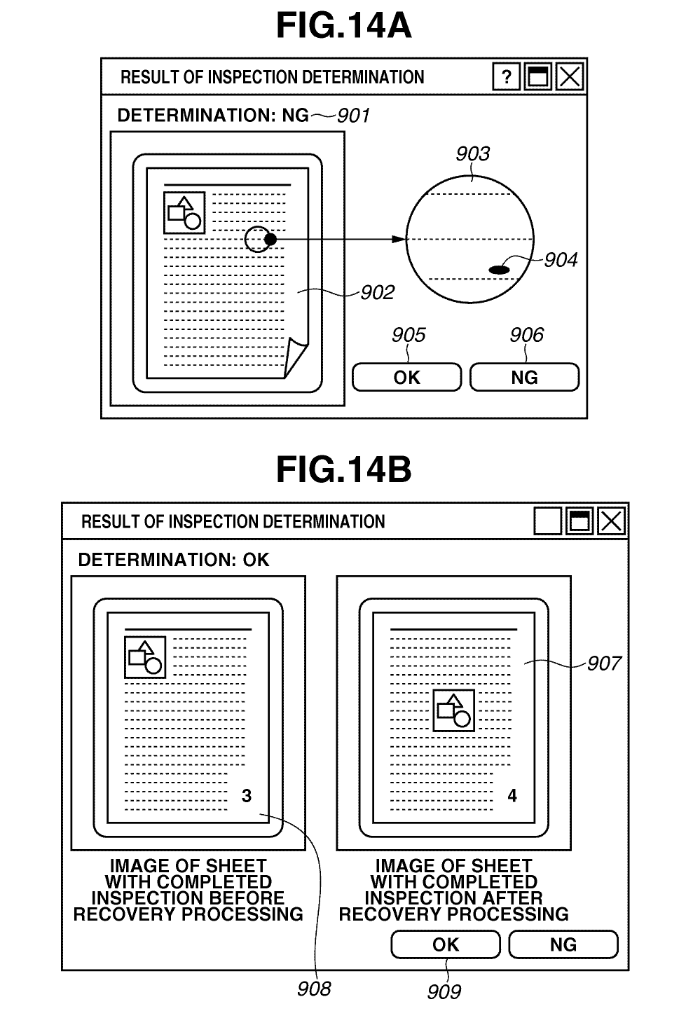

When a result of inspection for the first sheet after recovery processing is determined to be failure, the inspection apparatus control unit 610 instructs the image forming apparatus control unit 203 to display a user interface (UI) processing screen (FIG. 14A) on the operation unit 207 of the image forming device unit 101, and waits for a response from the image forming apparatus control unit 203. Specifically, when a result of inspection for after-recovery print processing on a specific number of sheets (one sheet in the present exemplary embodiment) is failure (a print failure), the inspection apparatus control unit 610 controls the inspection device unit 102 to display a portion of print failure occurrence and prompt the user to select whether the result of inspection is to be recognized as a print failure.

FIG. 14A illustrates an exemplary UI processing screen displayed on the operation unit 207 of the image forming device unit 101 when a result of inspection is determined to be failure in the second exemplary embodiment.

Referring to FIG. 14A, a result of determination 901 means that the result of inspection is determined to be failure.

A thumbnail display 902 indicates the entire image of a failed sheet. A failed portion display 903 displays almost in full size a portion determined to be a print failure, for example, a block determined to be failed.

The failed portion display 903 displays a smeary portion 904 on the sheet which indicates a failed portion. With the UI processing screen in FIG. 14A, the operator press a success (OK) button 905 or a failure (NG) button 906 on the touch panel to perform processing based the obtained result.

When the image forming apparatus control unit 203 detects that the user has pressed the OK button 905 or the NG button 906, it notifies the inspection apparatus control unit 610 of that fact.

For example, upon reception of a notification that the OK button 905 is pressed from the image forming apparatus control unit 203, the inspection apparatus control unit 610 controls the inspection device unit 102 to recognize a success (OK) result of inspection, and the processing proceeds to step S806.

Otherwise, upon reception of a notification that the NG button 906 is pressed from the image forming apparatus control unit 203, the inspection apparatus control unit 610 controls the inspection device unit 102 to recognize a failure result of inspection, and the processing proceeds to step S806.

In the case of an OK result of inspection for the first sheet after recovery processing, or in the case of inspection determination for the second and subsequent sheets, the inspection apparatus control unit 610 does not instruct the image forming apparatus control unit 203 to display the UI processing screen (FIG. 14A), and the processing proceeds to step S806.

In step S806, the inspection apparatus control unit 610 notifies the image forming device unit 101 of the result of inspection acquired in step S805, and the processing proceeds to step S807.

In step S807, the inspection apparatus control unit 610 returns the above-mentioned threshold values for inspection determination changed in step S803 from the threshold values for after-recovery inspection (the second density difference threshold value and the second OK determination threshold value) to the regular threshold values (the first density difference threshold value and the first OK determination threshold value), and the processing proceeds to step S808. Specifically, the inspection apparatus control unit 610 controls the inspection device unit 102 to apply inspection to sheets following a specific number of sheets (the second and subsequent sheets) based on the first level (an inspection level before recovery processing). Although not illustrated, the processing in step S807 is performed only when the threshold values for inspection determination are changed in step S803.

In step S808, the inspection apparatus control unit 610 determines whether the result of inspection acquired in step S805 is success (OK). When the inspection apparatus control unit 610 determines that the result of inspection is failure (NG) (a print failure: NO in step S808), the processing proceeds to failure processing. Although the failure processing by the inspection device unit 102 will not be described in detail, even during processing of a received job for example, the inspection apparatus control unit 610 controls the inspection device unit 102 not to apply inspection to the remaining sheets.

Otherwise, when the inspection apparatus control unit 610 determines that the result of inspection is success (OK) (not a print failure: YES in step S808), the processing proceeds to step S809.

In step S809, the inspection apparatus control unit 610 determines whether the job is completed. When the inspection apparatus control unit 610 determines that the job is not completed (NO in step S809), the processing returns to step S804. The inspection apparatus control unit 610 control 102 to capture the following sheet sent out from the image forming device unit 101 and repeat the processing in steps S804 to S809 until the job is completed.

Otherwise, when the inspection apparatus control unit 610 determines that the job is completed (YES in step S809), the processing ends this flow chart.

In the present exemplary embodiment based on the configuration of the first exemplary embodiment, the inspection apparatus control unit 610 changes the threshold values for inspection determination (threshold values for after-recovery inspection) to threshold values severer than the ones for regular inspection determination when performing after-recovery print processing on the first sheet for continuous jobs, thus more severely inspecting the first sheet after recovery processing for continuous jobs. This configuration enables preventing print medium from being wasted in more reliable way in the case of a print failure (for example, print medium smeared by recording material) due to after-recovery continuous print processing which is relatively highly likely to cause a print failure.

Even in the case of a failure result of inspection based on the threshold values for after-recovery inspection, the operator can confirm the extent of the print failure. Although the inspection apparatus control unit 610 changes the threshold values for inspection determination (at least one of the density difference threshold value and the OK determination threshold value), the resolutions of the reference image data and the print output scan data may be changed to a higher resolution before the image comparison and determination unit 607 performs image comparison and determination. The threshold values and resolutions may be changed at the same time.

The above-mentioned resolutions are changed by changing the scanning resolution of the inspection sensor 403, the conversion resolution of the resolution conversion unit 2 (606), or the conversion resolution of the resolution conversion unit 1 (605).

Although it is necessary that the inspection determination speed follows the printing speed at the time of continuous print processing, the inspection device unit 102 performs intermittent print and inspection processing after recovery processing. Therefore, in inspection after recovery processing (due to a specific factor), time-consuming inspection can be performed with higher accuracy based on an increased resolution.

A user setting may determine whether processing, with which a user instruction is accepted through the UI processing screen (FIG. 14A), is to be performed when a result of inspection is determined to be failure based on the threshold values for after-recovery inspection.

FIG. 14A illustrates an exemplary UI processing screen displayed when the result of inspection after recovery processing is failure (NG). FIG. 14B illustrates an exemplary UI processing screen displayed when the result of inspection after recovery processing is success (OK).

FIG. 14B illustrates an image 907 on a sheet determined to be successful (OK) as a result of inspection after recovery processing. By checking the image 907, the user can grasp which sheet has undergone inspection after recovery processing. When applying inspection after recovery processing from a middle point of a job, displaying an image (an image 908) of a sheet with completed inspection immediately before recovery processing together with an image (the image 907) of a sheet with completed inspection after recovery processing enables the user to grasp, without checking the print output, that print processing has been performed in correct order after recovery processing. The UI processing screen in FIG. 14B illustrates that inspection is completed for the first to third sheets, a recovery factor such as jam occurs on the fourth sheet and printing is interrupted, and after-recovery print and inspection, processing for the fourth sheet is completed. Checking the UI processing screen enables the user to grasp, without checking the print output, that print processing has been performed in correct order (specifically, the third and fourth sheets are printed in this order) after recovery processing.

Further, print processing on the second and subsequent sheets may be started when the user presses an OK button 909 after determining a result of inspection after recovery processing.

The present exemplary embodiment has specifically been described based on a case where the UI processing screens (FIGS. 14A and 14B) are displayed on the operation unit 207. However, when a job is transmitted from the client PC, the UI processing screens (FIGS. 14A and 14B) may be displayed on the display unit of the client PC. In this case, when the client PC detects that the user presses the OK button 905 or the NG button 906, it notifies the inspection apparatus control unit 610 of that fact.

The first and second exemplary embodiments have specifically been described based on a case where, when a result of inspection for after-recovery print processing on the first sheet is success (OK), continuous print processing on the following (the second and subsequent) sheets is started. However, when a result of inspection for after-recovery print processing on a specific plurality number of sheets is successful (OK), continuous print processing on sheets following the specific number of sheets may be started. Specifically, the image forming apparatus control unit 203 may control the printing apparatus 100 to interrupt print processing when a predetermined factor such as a factor requiring recovery processing is determined to have occurred and then, when the inspection device unit 102 determines that print processing on a predetermined number of sheets after print processing interruption does not cause a print failure, start print processing on sheets following the predetermined number of sheets.

As mentioned above, the inspection device unit 102 according to the present exemplary embodiment applies inspection to a specific number of sheets (one sheet in the present exemplary embodiment) after recovery processing (due to a specific factor) based on the second level higher than the first level (an inspection level before recovery processing). Thus, immediately after the printing apparatus 100 performs recovery processing which is relatively highly likely to cause failure (a print failure) as a result of inspection, severer inspection can be achieved.

The inspection device unit 102 applies inspection to sheets following the specific number of sheets (the second and subsequent sheets in the present exemplary embodiment) based on the first level (an inspection level before recovery processing). This enables applying inspection based on a regular inspection processing level to sheets following the specific number of sheets (the second and subsequent sheets in the present exemplary embodiment) which is not relatively highly likely to cause failure (a print failure) as a result of inspection, thus preventing a decrease in throughput due to inspection.

When a result of inspection for after-recovery print processing on a specific number of sheets (one sheet in the present exemplary embodiment) indicates a print failure, the inspection device unit 102 displays a portion determined to be a print failure and prompts the user to select whether the result of inspection is to be recognized as a print failure. This enables the user to apply inspection only to a portion which is highly likely to cause a print failure, thus achieving both the efficiency and accuracy of inspection.

The first and second exemplary embodiments have specifically been described based on a case where, when a result of inspection for a specific number of sheets (one sheet for example) after recovery processing (due to a specific factor) is success (OK), continuous print processing on sheets following the specific number of sheets is started. In a third exemplary embodiment, the user can variably set the number of sheets subjected to inspection after recovery processing. The present exemplary embodiment will be described in detail below.

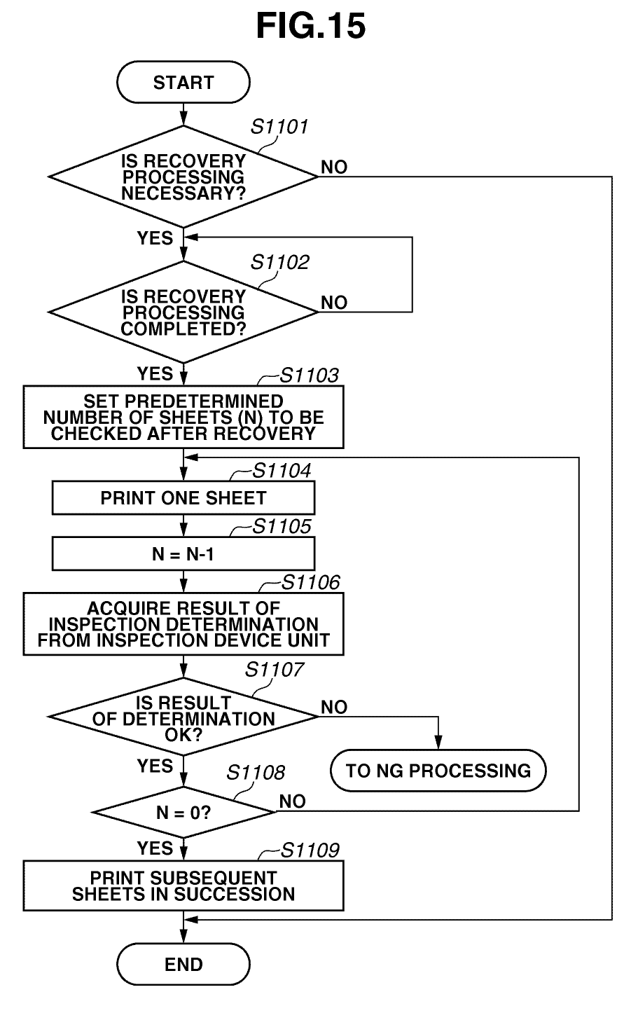

FIG. 15 is a flow chart illustrating processing performed by the image forming device unit 101 when a situation requiring recovery processing arises in the printing apparatus 100 according to the third exemplary embodiment of the present invention. Processing of this flow chart is performed by the image forming apparatus control unit 203.

During execution of continuous jobs, in step S1101, the image forming apparatus control unit 203 determines whether recovery processing is necessary for any one unit in the printing apparatus 100. When the image forming apparatus control unit 203 determines that recovery processing is necessary (YES in step S1101), the processing proceeds to step S1102. Otherwise (NO in step S1101), the processing ends this flow chart to continue regular processing.

In step S1102, the image forming apparatus control unit 203 waits for completion of recovery processing. When the image forming apparatus control unit 203 determines that recovery processing is completed (YES in step S1102), the processing proceeds to step S1103.

In step S1103, the image forming apparatus control unit 203 sets the number of sheets needed to be checked after recovery processing as a variable N and then restarts after-recovery job processing, and the processing proceeds to step S1104. The number of sheets needed to be checked after recovery processing is preset by the user from a specific number-of-sheets setting screen on the operation unit 207 of the image forming device unit 101 or from the display unit of the client PC, and then stored in the flash ROM in the image forming device unit 101. Further, the above-mentioned specific number-of-sheets setting screen for prompting the user to input the number of sheets needed to be checked after recovery processing may be displayed on the operation unit 207 of the image forming device unit 101 in step S1103, and a value input from the screen may be set as the variable N, i.e., the number of sheets needed to be checked after recovery processing. When an instruction for starting a job is input from the operation unit 207, the above-mentioned screen may be displayed on the operation unit 207. When the instruction is input from the client PC, the above-mentioned screen may be displayed on the display unit of the client PC.

In step S1104, the image forming apparatus control unit 203 controls the printing apparatus 100 to perform after-recovery print processing on the first sheet through intermittent print and inspection processing in which a result of inspection for print processing on one sheet is determined before starting print processing on a next sheet. Specifically, the image forming apparatus control unit 203 performs after-recovery print processing on the first sheet, sends it out to the inspection device unit 102, and waits for a response about a result of inspection from the inspection device unit 102. The inspection device unit 102 applies inspection determination to the first sheet after recovery processing output from the image forming device unit 101, and notifies the image forming apparatus control unit 203 of a result of print processing.

In step S1105, the image forming apparatus control unit 203 decrements the variable N by one (N=N−1) for the sheet printed out in step S1104.

In step S1106, the image forming apparatus control unit 203 receives a result of inspection from the inspection device unit 102. In step S1107, the image forming apparatus control unit 203 determines the result of inspection.

When the image forming apparatus control unit 203 determines that the result of inspection is failure (NO in step S1107), the processing proceeds to failure (NG) processing. Although the failure processing by the image forming device unit 101 will not be described in detail below, for example, the failure processing performs reprint processing on a sheet determined to be failed (a print failure) as a result of inspection.

Otherwise, when the image forming apparatus control unit 203 determines that the result of inspection is success (OK) (YES in step S1107), the processing proceeds to step S1108.

In step S1108, the image forming apparatus control unit 203 determines whether the variable N becomes “0” (N=0). When the image forming apparatus control unit 203 determines that the variable N has not yet become “0” (NO in step S1108), the processing repeats steps S1104 to S1107 until the variable N becomes “0”.

When the image forming apparatus control unit 203 determines that the variable N has become “0” (N=0) (YES in step S1108), the processing proceeds to step S1109. In step S1109, determining that after-recovery intermittent print processing is successfully completed, the image forming apparatus control unit 203 controls the printing apparatus 100 to proceed to regular continuous print processing.

Even in the present exemplary embodiment, the image forming apparatus control unit 203 may control the printing apparatus 100 to apply intermittent print and inspection processing to a specific number of sheets after recovery processing due to the specific factor and then start continuous print processing for jobs for sheets following the specific number of sheets, or control the printing apparatus 100 to simply start continuous print processing after recovery processing due to a factor other than the specific factor.

In this way, the present exemplary embodiment enables the user to set the number of sheets needed to be checked after recovery processing (due to a specific factor) for continuous jobs, thus achieving more flexible inspection after recovery processing.

Of course, the above-mentioned various data configurations are not limited thereto but may be modified in diverse ways according to application and purpose.

Although an exemplary embodiment has been described above, the present invention may be embodied as any one of a system, an apparatus, a method, a program, a storage medium, and so on. Specifically, the present invention may be applied to a system composed of a plurality of devices, or to an apparatus composed of one device.

Further, any configurations combining the above-mentioned exemplary embodiments are also included in the present invention.

As mentioned above, the printing apparatus according to the present invention is capable of preventing smeared paper and an image defect due to recording material as well as preventing paper and recording material from being wasted, even immediately after recovery processing which is relatively highly likely to cause a print failure. Thus, the printing apparatus can efficiently produce a high-quality print output without wasting paper.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-129213 filed Jun. 4, 2010, which is hereby incorporated by reference herein in its entirety.

What is claimed is:

1. A printing apparatus comprising:
a printing unit configured to perform print processing on a sheet based on first image data;
an acquisition unit configured to acquire a result of inspection for inspecting whether a print failure occurs in the print processing by comparing the first image data with second image data generated by reading the sheet on which the print processing has been performed; and
a control unit configured to control, when print processing is interrupted and then restarted, the printing unit to perform print processing on a specific number of sheets and then, after determining that a result of inspection for the specific number of sheets does not indicate a print failure, start print processing on sheets following the specific number of sheets.

2. The printing apparatus according to claim 1, wherein the result of inspection is acquired from an inspection apparatus connected to the printing apparatus.

3. The printing apparatus according to claim 1, further comprising:
a reading unit configured to read the sheet on which the print processing has been performed to generate the second image data.

4. The printing apparatus according to claim 1, wherein the specific number of sheets is one.

5. The printing apparatus according to claim 1, wherein the specific number of sheets is settable by a user.

6. The printing apparatus according to claim 1, wherein an inspection reference value used in inspection after the print processing is restarted is different from an inspection reference value used in inspection before the print processing is restarted.

7. The printing apparatus according to claim 1, further comprising:
a display unit configured to display the result of inspection.

8. The printing apparatus according to claim 1, further comprising:
a specification unit configured to allow the user to specify a factor for interrupting the print processing,
wherein, when the print processing interrupted due to the factor specified by the specification unit is restarted, the control unit controls the printing unit to perform print processing on a specific number of sheets and then, after determining that a result of inspection for the specific number of sheets does not indicate a print failure, start print processing on sheets following the specific number of sheets.

9. The printing apparatus according to claim 1, wherein print processing is interrupted due to any one of factors including paper out, paper jam, and recording material replacement.

10. A method for controlling a printing apparatus, the method comprising:
performing print processing on a sheet based on first image data;
acquiring a result of inspection processing using the first image data and second image data generated by reading the sheet on which the print processing has been performed; and
performing, when print processing is interrupted and then restarted, print processing on a specific number of sheets and then, after determining that a result of inspection for the specific number of sheets does not indicate a print failure, starting print processing on sheets following the specific number of sheets.

11. A computer-readable storage medium storing a program for causing a computer to execute the method according to claim 10.
